(19) United States
(12) Patent Application Publication
(10) Pub. No.: US 2010/0317212 A1
(43) Pub. Date: Dec. 16, 2010

(54) END CAP ASSEMBLY FOR A LIGHT TUBE

(75) Inventor: CHRISTOPHER GEORGE DAILY, HARRISBURG, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: Tyco Electronics Corporation, BERWYN, PA (US)

(21) Appl. No.: 12/484,629

(22) Filed: Jun. 15, 2009

(51) Int. Cl. H01R 33/08

(52) U.S. Cl. 439/230

(57) ABSTRACT

An end cap assembly for a light tube that has a circuit board with lighting devices mounted thereto includes an end cap body coupled to the light tube. The end cap body has an external mating face configured to mate with a socket connector of a fixture. The end cap body includes contact bores therethrough extending along parallel bore axes between inner ends and outer ends. Contacts are received in the contact bores along the bore axes. The contacts have socket mating ends extending from the contact bores beyond the outer ends for mating with the socket connector. The contacts have wire termination ends opposite to the socket mating ends. Wires are terminated to the wire termination ends of the contacts. The wires are configured to be electrically connected to the circuit board. Optionally, the contacts may be crimped to the wires. Alternatively, the contacts may be poke-in wire contacts that receive the wires.

### BACKGROUND OF THE INVENTION

The subject matter herein relates generally to lighting assemblies, and more particularly, to an end cap assembly for a light tube.

Solid state light sources, such as light-emitting diodes (“LEDs”), organic light emitting devices or other solid state sources, are now widely applied in a variety of lighting applications. The relatively high efficacy of LEDs (in lumens per watt) is the primary reason for their popularity. Power savings and extended lamp life are possible when LEDs are used to replace traditional fluorescent lighting. Solid state light tubes are in use to replace traditional fluorescent bulbs. The solid state light tubes are typically assembled into a light tube having a circuit board with a plurality of LEDs or other solid state light sources electrically connected thereto. The light tube may or may not include a thermal dissipation device. The light tube may be linear or some other shape, such as circular, U-shaped and the like. A lens generally covers the circuit board and LEDs to direct the light in a pattern as dictated by the end application. The light tubes are sized and shaped generally the same as traditional fluorescent bulbs.

Solid state light tubes are typically designed into fixtures specifically designed to take advantage of the solid state light tubes. However, a large number of traditional fluorescent fixtures are currently in use. Replacement of these fixtures with specifically designed solid state lighting fixtures may be impractical or cost prohibitive for some people. As a result, some solid state lighting assemblies have been designed to retrofit into traditional fluorescent lamp fixtures with minimal modifications necessary.

Problems arise in retrofitting the solid state light tubes to fit into traditional fluorescent lamps. For example, the electrical connection between the circuit board and the traditional dual-pins that comprise the electrical contacts of a fluorescent tube may be complex and expensive to manufacture. Typically, a dual-pin contact cap of a conventional fluorescent bulb is provided at the end of the light tube, and are electrically connected to the circuit board by wires that are soldered between the pins of the contact cap and the circuit board. Manufacturing solid state light tubes in this manner is time-consuming, expensive and difficult.

A need remains for solid state light tube components that facilitate cost-effective and reliable mass production manufacturing. Further, a need remains for solid state light tube components that allow the solid state light tube to retrofit into traditional fluorescent lamp fixtures in a simple and cost-effective manner.

### BRIEF DESCRIPTION OF THE INVENTION

In one embodiment, an end cap assembly is provided for a light tube that has a circuit board with lighting devices mounted thereto. The end cap assembly includes an end cap body coupled to the light tube. The end cap body has an external mating face configured to mate with a socket connector of a fixture. The end cap body includes contact bores therethrough extending along parallel bore axes between inner ends and outer ends. Contacts are removably received in the contact bores along the bore axes. The contacts have socket mating ends extending from the contact bores beyond the outer ends for mating with the socket connector. The contacts have wire termination ends opposite to the socket mating ends. Wires are terminated to the wire termination ends of the contacts. The wires are configured to be electrically connected to the circuit board. Optionally, the contacts may be crimped to the wires. Alternatively, the contacts may be poke-in wire contacts that receive the wires.

In another embodiment, an end cap assembly for a light tube that has a circuit board with lighting devices mounted thereto is provided including an end cap body coupled to the light tube. The end cap body has an external mating face configured to mate with a socket connector of a fixture. The end cap body has contact bores therethrough extending along parallel bore axes between inner ends and outer ends. Contacts are loaded into the contact bores along the bore axes. The contacts have socket mating ends extending from the contact bores beyond the outer ends for mating with the socket connector. The contacts have deflectable retention lances extending outward therefrom that engage the contact bores to hold the contacts in the contact bores. The contacts are electrically connected to the circuit board.

In a further embodiment, an end cap assembly is provided for a light tube that has a circuit board with lighting devices mounted thereto and a lens covering the circuit board. The end cap assembly includes an end cap body having a lens engagement surface configured to engage the lens and an external mating face configured to mate with a socket connector of a fixture. The end cap body has contact bores therethrough extending along parallel bore axes. Poke-in wire contacts are received in the contact bores along the bore axes. The contacts having wire termination ends receiving wires therethrough and being electrically connected to the wires. The contacts have socket mating ends extending outward from the external mating face for mating with the socket connector. The contacts are electrically connected to the circuit board by the wires.

### BRIEF DESCRIPTION OF THE DRAWINGS

FIG. 1 illustrates a lighting system utilizing a light tube that is assembled into a ballast using end cap assemblies formed in accordance with an exemplary embodiment.

FIG. 2 is a front perspective view of an exemplary end cap assembly for use with the light tube shown in FIG. 1.

FIG. 3 is a rear perspective view of the end cap assembly shown in FIG. 2.

FIG. 4 is a front perspective view of an alternative end cap assembly for use with the light tube shown in FIG. 1.

FIG. 5 is a rear perspective view of the end cap assembly shown in FIG. 4.

FIG. 6 is a front perspective view of another alternative end cap assembly for use with the light tube shown in FIG. 1.

FIG. 7 is a rear perspective view of the end cap assembly shown in FIG. 6.

### DETAILED DESCRIPTION OF THE INVENTION

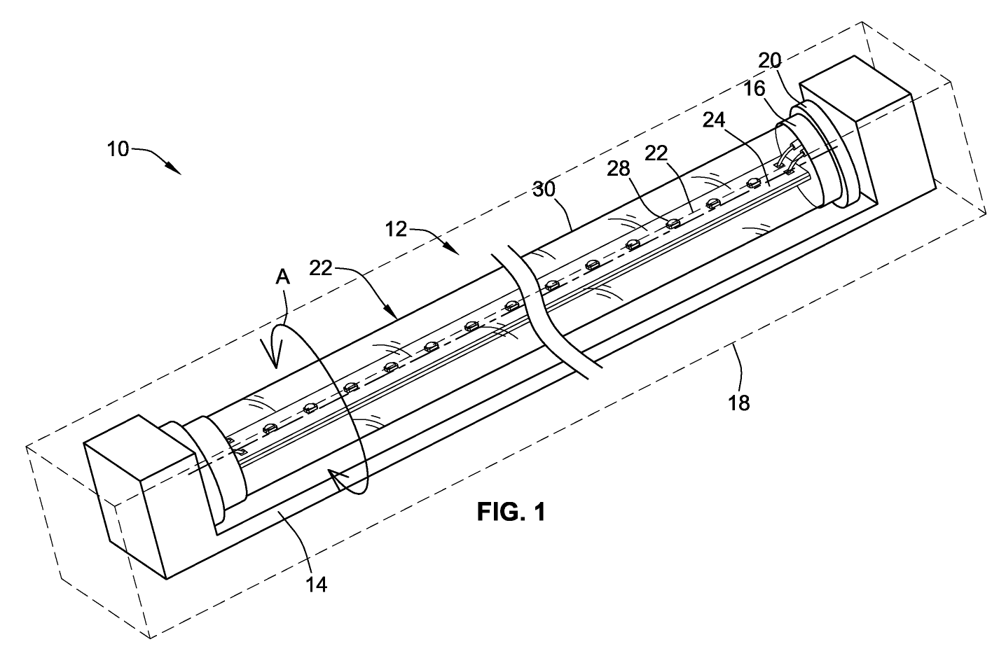

FIG. 1 illustrates a lighting system 10 utilizing a solid state light tube 12 that is assembled into a ballast 14 using end cap assemblies 16 formed in accordance with an exemplary embodiment. In an exemplary embodiment, the ballast 14, only a portion of which is illustrated in FIG. 1, may be a traditional fluorescent lamp ballast that is used in a fluorescent lamp fixture 18 (represented schematically in phantom in FIG. 1). The ballast 14 receives power from a traditional power supply, such as a line voltage from a building, and provides power to the light tube 12. The light tube 12 may be connected to socket connectors 20 of the ballast 14 in a traditional manner, such as by rotating the end cap assemblies 16 into the socket connectors 20, as shown by arrow A. The socket connector 20 may include a circular slot or groove (not shown) that receives a portion of the end cap assembly 16 for making electrical connection with the end cap assembly 16, where the end cap assembly 16 is rotated within the slot to make a mechanical and electrical connection with the socket connector 20.

The light tube 12 extends between the end cap assemblies 16. The light tube 12 includes one or more circuit boards 22 extending along a longitudinal axis 24 of the light tube 12. In an exemplary embodiment, the end cap assemblies 16 are electrically connected to the circuit board 22 by wires 26 that extend therebetween. Alternatively, the end cap assemblies 16 may be directly electrically connected to the circuit board 22, such as by a direct electrical connection with an element or contact of the end cap assembly, such as the configurations described in U.S. patent application Ser. No. 12/367,044, filed on Feb. 6, 2009, titled END CAP ASSEMBLY FOR A LIGHT TUBE, the complete disclosure of which is herein incorporated by reference in its entirety. The circuit board 22 is electrically connected to either one or both of the end cap assemblies 16. Power is provided from the socket connectors 20 to the circuit board 22 by the end cap assemblies 16.

A plurality of solid state lighting devices 28 are electrically connected to the circuit board 22 and are arranged in a predetermined pattern to emit light from the light tube 12. In an exemplary embodiment, the lighting devices 28 are represented by light emitting diodes (LEDs) and may be referred to hereinafter as LEDs 28. Any number of LEDs 28 may be provided on the circuit board 22. The power supplied to the circuit board 22 is transmitted along the circuit board 22 to the LEDs 28.

A lens 30 covers at least a portion of the circuit board 22 and the LEDs 28. The lens 30 may extend at least partially circumferentially around the circuit board 22 and the LEDs 28. In the illustrated embodiment, the lens 30 extends entirely circumferentially around the circuit board 22 and the LEDs 28 to define a closed tube. In an alternative embodiment, the lens 30 may extend only partially circumferentially around the circuit board 22 and the LEDs 28 to define an open tube. Optionally, the lens 30 may be provided outward from the circuit board 22 and the LEDs 28 in the direction in which light is intended to be illuminated. For example, if light is illuminated from half of the light tube 12 (for example approximately 180°), then the lens 30 need only extend along half of the light tube 12 (for example, approximately 180°).

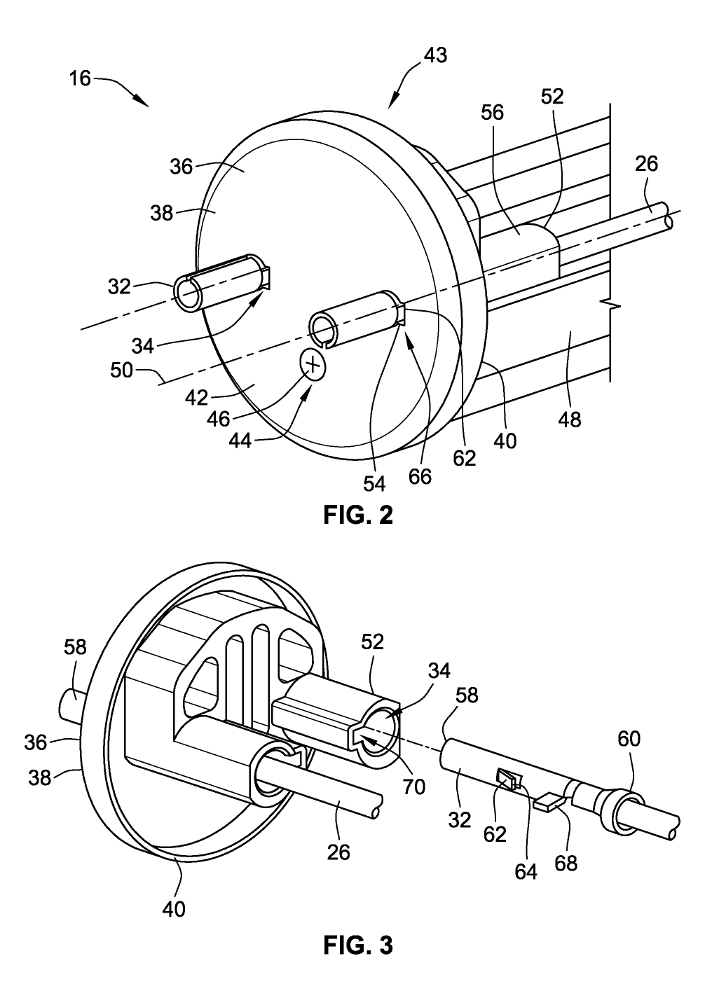

FIG. 2 is a front perspective view of a portion of the light tube 12 and end cap assembly 16. The lens 30 (shown in FIG. 1) has been removed for clarity. The light tube 12 includes the circuit board 22 with the LEDs 28 mounted thereto. The end cap assembly 16 is mounted to the end of the light tube 12. The end cap assembly 16 provides the electrical interface between the socket connector 20 (shown in FIG. 1) and the circuit board 22 and LEDs 28 of the light tube 12. The end cap assembly 16 is electrically connected to the circuit board 22 by the wires 26. For example, the wire 26 may be soldered to the circuit board 22. Alternatively, the wire 26 may have a contact at the end thereof that is electrically connected to the circuit board 22 or a connector mounted to the circuit board. The wire 26 may be connected to a contact on the circuit board by a poke-in type connection. Other alternative connection means are possible in alternative embodiments. Different end cap assemblies having different geometries or designs, such as different mating interfaces, may be coupled to the end of the light tube 12 to provide a particular mating interlace for mating with a particular socket connector 20.

The end cap assembly 16 includes a pair of contacts 32 that are received within, and extend from, contact bores 34 in the end cap assembly 16. The contacts 32 are configured to electrically connect with mating contacts of the socket connector 20 and with the circuit board 22. In the illustrated embodiment, the contacts 32 define pins having circular cross-sections at the socket mating portion of the contacts 32. The pins are configured to be coupled with a bi-pin type socket connector, such as those typical of a fluorescent lamp fixture.

The end cap assembly 16 has an end cap body 36 extending between an outer end 38 and an inner end 40. The contact bores 34 extend through the end cap body 36 between the outer and inner ends 38, 40. The outer end 38 of the end cap body 36 is substantially flat and planar. The contacts 32 extend outward from the outer end 38 of the end cap body 36.

The end cap body 36 defines an external mating face 42 at the outer end 38 thereof. The mating face 42 and the contacts 32 are configured for mating with one of the socket connectors 20 (shown in FIG. 1). Optionally, the mating face 42 and contacts 32 may be an industry standard mating interface for a traditional fluorescent lamp fixture. In the illustrated embodiment, the end cap assembly 16 is configured for mating with a bi-pin type socket connector. The end cap body 36 defines a lens engagement surface 43 at the inner end 40 thereof. The lens engagement surface 43 is configured to engage the lens 30 when the end cap assembly 16 is coupled to the light tube 12.

A mounting opening 44 extends through the end cap body 36. The mounting opening 44 receives a fastener 46 for securing the end cap assembly 16 to the light tube 12. The fastener 46 may be secured to the circuit board 22, or a component extending from the circuit board 22. Optionally, a heat sink 48 may be coupled to the circuit board 22, and the fastener 46 may be secured to the heat sink 48.

The contact bores 34 extend along bore axes 50 between an inner end 52 and an outer end 54. The contacts 32 are received within the contact bores 34 along the bore axes 50. In an exemplary embodiment, the contacts 32 extend from the contact bores 34 beyond the outer ends 54 for mating with the socket connector 20. The outer end 54 may be aligned with the outer end 38 of the end cap body 36. Alternatively, the outer end 54 may extend forward of the outer end 38 of the end cap body 36. For example, tubes or another structure may extend forward of the outer end 38 of the end cap body 36. The contact bores 34 may have any length between the inner and outer ends 52, 54. In the illustrated embodiment, the end cap assembly 16 includes tubes 56 extending rearward from the inner end 40 of the end cap body 36. The contact bores 54 are defined by the hollow interior of the tubes 56. The tubes 56 define added length for the contact bores 34 in addition to the width of the end cap body 36, which also defines part of the contact bores 34. The tubes 56 and the end cap body 36 provide electrical isolation between the contacts 32.

FIG. 3 is a rear perspective view of the end cap assembly 16 with one of the contacts 32 loaded into the corresponding contact bore 34 and the other contact 32 being loaded into the corresponding contact bore 34. In the illustrated embodiment, the contacts 32 are loaded into the contact bores 34 through the inner ends 52 of the contact bores 34. The contacts 32 may be held within the contact bores 34 by a snap fit. For example, portions of the contacts 32 may engage the contact bores 34 in a deflectable latching configuration. Alternatively, portions of the contact bores 34 may engage the contacts 32 in a deflectable latching configuration. For example, the contact bores 34 may have latches that engage the contacts 32. The contacts 32 are terminated to the ends of the wires 26 prior to the contacts 32 being loaded into the contact bores 34.

Each contact 32 includes a conductive body electrically connected to one of the wires 26. In an exemplary embodiment, the contacts 32 is stamped and formed into a tubular shape having a hollow interior. The wire 26 is at least partially received within the hollow interior of the contact 32. The contact 32 has a socket mating end 58 and a wire termination end 60. The socket mating end 58 extends from the contact bore 34 beyond the outer end 38 of the end cap body 36 for mating with the socket connector 20. For example, the socket mating end 58 may define a pin extending from the end cap body 36 that is received within the socket connector 20 to make electrical contact with the socket connector 20. The wire termination end 60 is arranged proximate to the inner end 52 of the contact bores 34. The wire termination end 60 is mechanically and electrically connected to the end of the wire 26. The contact 32 is hollow at the wire termination end 60, and the wire 26 is received within the hollow portion of the contact 32. In the illustrated embodiment, the wire termination end 60 is crimped to the end of the wire 26. Other types of mechanical and electrical connections between the wire and the wire termination end 60 are possible in alternative embodiments.

The contact 32 includes one or more retention lances 62 extending outward from the contact 32. In an exemplary embodiment, the retention lances 62 are deflectable and are splayed outward at an angle from the contact 32. A distal end 64 of each retention lance 62 is generally rearward facing and spaced apart from the outer surface of the contact 32. During loading of the contact 32 into the contact bore 34, the retention lances 62 may be deflected inward by interference with the inner surface of the contact bore 34. In an exemplary embodiment, the contact bores 34 include counter bores 66 (shown in FIG. 2) that extend radially outward from the contact bores 34 to define a shelf for ledge within the contact bores 34. The counter bores 66 are sized and shaped to receive the retention lances 62. When the contact 32 is fully loaded, the retention lances 62 are aligned with the counter bores 66 and allowed to deflect outward from the contact 32. When received in the counter bores 66, the retention lances 62 hold the contact 32 in the contact bore 34. For example, the distal ends 64 engage the shelf defined by the counter bores 66 to resist movement of the contacts 32 out of the contact bores 34. For example, the retention lances 62 may resist removal of the contacts 32 from the contact bores 34 in a rearward direction. Optionally, the retention lances 62 may be deflected inward by a tool or device to allow removal of the contact 32 from the contact bore 34. As illustrated in FIG. 2, the counter bores 66 are provided at the outer end 38 of the end cap body 36. The counter bores 66 are accessible through the outer end 38. The contacts 32 are loaded into the contact bores 34 until the retention lances 62 are aligned with the counter bores 66. In the Illustrated embodiment, the retention lances 62 are held internal with respect to the contact bores 34. The retention lances 62 do not extend forward of the outer end 38. As such, the portion of the contacts 32 extending from the end cap body 36 is cylindrically shaped.

The contact 32 includes a tab 68 extending outward from the body of the contact 32. Optionally, the tab 68 may extend radially outward, however the tab 68 may be angled at any angle from the body of the contact 32. The tab 68 is configured to be received in a slot 70 within the contact bore 34. The slot 70 is sized and shaped to receive the tab 68. The tab 68 may be used as a guidance feature during loading of the contact 32 into the contact bore 34. The tab 68 may be used to stabilize the contact 32 within the contact bore 34. For example, the interference between the tab 68 and the slot 70 may resist rotation of the contact 32 within the contact bore 34. Such a feature may protect the retention lances 62 from damage caused by rotation of the contact 32 within the contact bore 34. Additionally, such a feature resists accidental or unintended deflection of the retention lances 62, which could allow the contact 32 to inadvertently be removed from the contact bore 34. Optionally, the tab 68 may defined in loading stop for the contact 32. For example, the contact 32 may be loaded into the contact bore 34 until the tab 68 bottoms out at an end of the slot 70. The tab 68 may be integrally formed with the contact 32 and positioned by stamped and forming the contact 32.

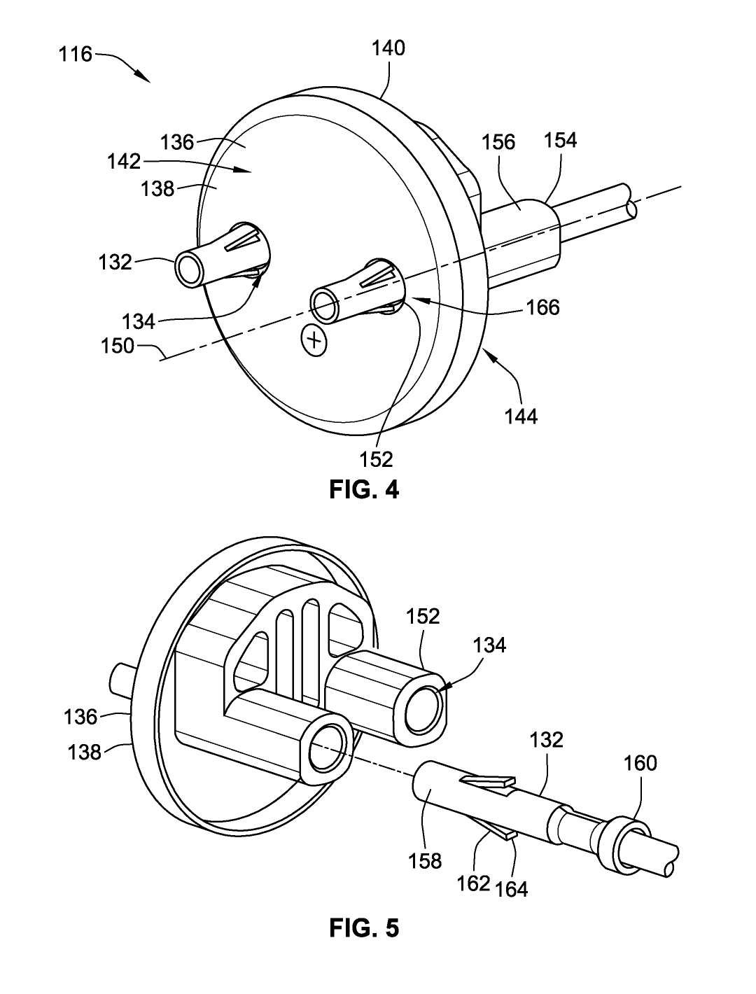

FIG. 4 is a front perspective view of an alternative end cap assembly 116 for use with the light tube 12 (shown in FIG. 1). The end cap assembly 116 may be mounted to the end of the light tube 12 in a similar manner as the end cap assembly 16 (shown in FIG. 1), relative to the circuit board 22, lens 30 and/or heat sink 48 (shown in FIGS. 2 and 3). The end, cap assembly 116 may be used with other types of light tubes in alternative embodiments.

The end cap assembly 116 includes a pair of contacts 132 that are received within, and extend from, contact bores 134 in the end cap assembly 116. The contacts 132 are configured to electrically connect with mating contacts of the socket connector 20 (shown in. FIG. 1). The contacts 132 are configured to electrically connect to the circuit board 22 by the wires 26, which are electrically and mechanically connected to the contacts 132. In the illustrated embodiment, the contacts 132 define pins having circular cross-sections at the socket mating portion of the contacts 132. The pins are configured to be coupled with a bi-pin type socket connector, such as those typical of a fluorescent lamp fixture.

The end cap assembly 116 has an end cap body 136 extending between an outer end 138 and an inner end 140. The contact bores 134 extend through the end cap body 136 between the outer and inner ends 138, 140. The outer end 138 of the end cap body 136 is substantially flat and planar. The contacts 132 extend outward from the outer end 138 of the end cap body 136.

The end cap body 136 defines an external mating face 142 at the outer end 138 thereof. The mating face 142 and the contacts 132 are configured for mating with one of the socket connectors 20 (shown in FIG. 1). The end cap body 136 defines a lens engagement surface 144 at the inner end 140 thereof. The lens engagement surface 144 is configured to engage the lens 30 when the end cap assembly 116 is connected to the light tube 12.

The contact bores 134 extend along bore axes 150 between an inner end 152 and an outer end 154. The contacts 132 are received within the contact bores 134 along the bore axes 150. Optionally, the contacts 132 are loaded into the contact bores 134 and secured therein by a snap fit. The contacts 132 are removable from the contact bores 134. In an exemplary embodiment, the contacts 132 extend from the contact bores 134 beyond the outer ends 154 for mating with the socket connector 20. In the illustrated embodiment, the end cap assembly 116 includes tubes 156 extending rearward front the inner end 140 of the end cap body 136. The contact bores 154 are defined by the hollow interior of the tubes 156. The tubes 156 and the end cap body 136 provide electrical isolation between the contacts 132.

FIG. 5 is a rear perspective view of the end cap assembly 116 illustrating one of the contacts 132 being loaded into the corresponding contact bore 134. The contact 132 is loaded into the contact bore 134 through the inner end 152 of the contact bore 134. The contacts 132 are terminated to the ends of the wires 26 prior to the contacts 132 being loaded into the contact bores 134.

Each contact 132 includes a conductive body electrically connected to one of the wires 26. In an exemplary embodiment, the contact 132 is stamped and formed into a tubular shape having a hollow interior. The wire 26 is at least partially received within the hollow interior of the contact 132. The contact 132 has a socket mating end 158 and a wire termination end 160. The socket mating end 158 extends from the contact bore 134 beyond the outer end 138 of the end cap body 136 for mating with the socket connector 20. For example, the socket mating end 158 may define a pin extending from the end cap body 136 that is received within the socket connector 20 to make electrical contact with the socket connector 20. The wire termination end 160 is arranged proximate to the inner end 152 of the contact bores 134. Optionally, the wire termination end 160 may extend rearward from the inner end 152 such that a portion of the wire termination end 160, is exposed. The wire termination end 160 is mechanically and electrically connected to the end of the wire 26. The contact 132 is hollow at the wire termination end 160, and the wire 26 is received within the hollow portion of the contact 132. In the illustrated embodiment, the wire termination end 160 is crimped to the end of the wire 26. Other types of mechanical and electrical connections between the wire and the wire termination end 160 are possible in alternative embodiments.

The contact 132 includes one or more retention lances 162 extending outward from the contact 132. In an exemplary embodiment, the retention lances 162 are deflectable and are splayed outward at an angle from the contact 132. A distal end 164 of each retention lances 162 is generally rearward facing and spaced apart from the outer surface of the contact 132. During loading of the contact 132 into the contact bore 134, the retention lances 162 may be deflected inward by interference with the inner surface of the contact bore 134. The retention lances 162 snap outward to secure the contact 132 within the contact bore 134.

As Illustrated in FIG. 4, the contact bores 134 include counter bores 166 in the form of a rim surrounding the contact bore 134 at the outer end 138 of the end cap body 136. The counter bores 166 define shelves or ledges that interact with the lances 162 to retain the contacts 132 within the contact bores 134. The counter bores 166 are sized and shaped to receive the distal ends 164 of the retention lances 162. The contact 132 is loaded into the contact bore 134 until the retention lances 162 clear the outer end 138 of the end cap body 136. The retention lances 162 are allowed to deflect outward from the contact 132 once the retention lances 162 clear the outer end 138 and are lined with the counter bores 166. When received in the counter bore 166, the retention lances 162 hold the contact 132 in the contact bore 134. For example, the distal ends 164 engage the outer end 138 of the end cap body 136 defining the counter bores 166 to resist movement of the contact 132 out of the contact bore 134. For example, the retention lances 162 may resist removal of the contacts 132 from the contact bores 134 in a rearward direction. Optionally, the retention lances 162 maybe deflected inward by a tool or device to allow removal of the contact 132 from the contact bore 134. In the illustrated embodiment, the retention lances 162 are positioned external with respect to the contact bores 134 forward of the outer end 138. Optionally, the end cap body 136 may not include any counter bores 166. Rather, the retention lances 162 engage the planar outer end 138 of the end cap body 136.

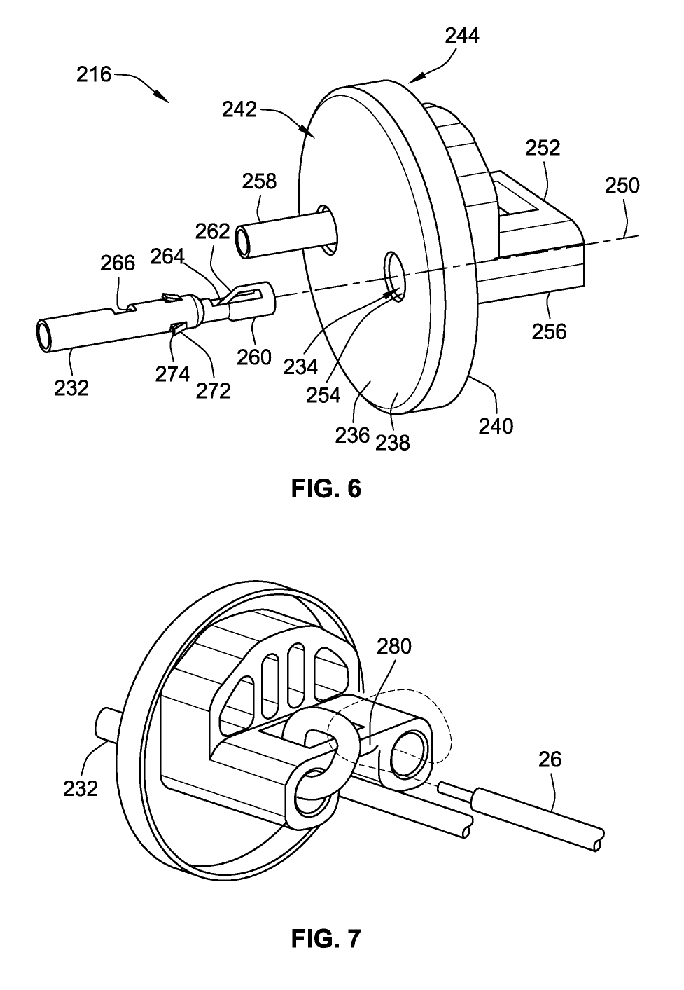

FIG. 6 is a front perspective view of another alternative end cap assembly 216 for use with the light tube 12 (shown in FIG. 1). The end cap assembly 216 may be mounted to the end of the light tube 12 in a similar manner as the end cap assembly 16 (shown in FIG. 1), relative to the circuit board 22, lens 30 and/or Heat sink 48 (shown in FIGS. 2 and 3). The end cap assembly 216 may be used with other types of light tubes in alternative embodiments.

The end cap assembly 216 includes a pair of contacts 232 that are received within, and extend from, contact bores 234 In the end cap assembly 216. FIG. 6 illustrates one of the contacts 232 being loaded into the corresponding contact bore 234. The contacts 232 are configured to electrically connect with mating contacts of the socket connector 20 (shown in FIG. 2). The contacts 232 are configured to electrically connect to the circuit board 22 by the wires 26, which are electrically and mechanically connected to the contacts 232. In the illustrated embodiment, the contacts 232 define pins having circular cross-sections at the socket mating portion of the contacts 232. The pins are configured to be coupled with a bi-pin type socket connector, such as those typical of a fluorescent lamp fixture.

The end cap assembly 216 has an end cap body 236 extending between an outer end 238 and an inner end 240. The contact bores 234 extend through the end cap body 236 between the outer and inner ends 238, 240. The outer end 238 of the end cap body 236 is substantially flat and planar. The contacts 232 extend outward from the outer end 238 of the end cap body 236.

The end cap body 236 defines an external mating face 242 at the outer end 238 thereof. The mating face 242 and the contacts 232 are configured for mating with one of the socket connectors 20 (shown in FIG. 2). The end cap body 236 defines a lens engagement surface 244 at the inner end 240 thereof. The lens engagement surface 244 is configured to engage the lens 30 when the end cap assembly 216 is connected to the light tube 22.

The contact bores 234 extend along bore axes 250 between an inner end 252 and an outer end 254. The contacts 232 are received within the contact bores 234 along the bore axes 250. In an exemplary embodiment, the contacts 232 extend from the contact bores 234 beyond the outer ends 254 for mating with the socket connector 20. In the illustrated embodiment, the end cap assembly 216 includes tubes 256 extending rearward from the inner end 240 of the end cap body 236. The contact bores 254 are defined by the hollow interior of the tubes 256.

Each contact 232 includes a conductive body electrically connected to one of the wires 26. In an exemplary embodiment, the contact 232 is stamped and formed into a tubular shape having a hollow interior. The contact 232 has a socket mating end 258 and a wire termination end 260. The socket mating end 258 extends from the contact bore 234 beyond the outer end 238 of the end cap body 236 for mating with the socket connector 20. The wire 26 is configured to be electrically and mechanically connected to the wire termination end 260. The contact 232 is hollow at the wire termination end 260, and the wire 26 is received within the hollow portion of the contact 232.

In the illustrated embodiment, the contact 232 defines a poke-in wire contact, wherein the stripped wire 26 is configured to he poked into the wire termination end 260 to make electrical and mechanical connection with the contact 232. The contact 232 includes a mating finger 262 extending into a hollow interior of the contact 232. The mating finger 262 is configured to engage the wire 26 when the wire 26 is poked into the wire termination end 260 of the contact 232. The mating finger 262 includes a tip 264 at the distal end thereof. The tip 264 may be biased against the exposed portion of the wire 26 to make electrical connection with the wire 26. When the wire 26 is loaded into the contact 232, the mating finger 262 may deflect outward, imparting a normal force onto the wire 26. Optionally, more than one mating finger 262 may be provided. The mating fingers 262 may be aligned with one another, or alternatively, may be staggered along the length of the wire 26. Other types of mechanical and electrical connections, other than a poke-in type of connection, between the wire and the wire termination end 260 are possible in alternative embodiments.

The contact 232 includes a wire stop 266 extending into the hollow interior of the contact 232. The wire stop 266 maybe defined by a portion of the contact body that is folded into the hollow interior of the contact 232. The wire 26 may be loaded into the contact 232 until the wire engages the wire stop 266. The wire stop 266 stops further loading of the wire 26 into the contact 232.

The contact 232 includes one or more retention lances 272 in the form of barbs that extending outward from the contact 232. In an exemplary embodiment, the retention lances 272 are deflectable and are normally splayed outward at an angle from the contact 232. A distal end 274 of each retention lances 272 is generally forward facing and spaced apart from the outer surface of the contact 232. During loading of the contact 232 into the contact bore 234, the retention lances 272 may be deflected inward by interference with the inner surface of the contact bore 234. In an exemplary embodiment, the contact bores 234 include internal counter bores (not shown) that extend radially outward from the contact bores 234. The counter bores are sized and shaped to receive the retention lances 272. When the contact 232 is fully loaded, the retention lances 272 are aligned with the counter bores and allowed to deflect outward from the contact 232. The retention lances 272 define allow the contact 232 to be secured within the contact bores 234 by a snap fit type of connection, wherein the contacts are loaded into the contact bores 234 until the retention lances 272 snap into engagement with the contact bores 234. When received in the counter bores, the retention lances 272 hold the contact 232 in the contact bore 234. The contacts 232 are removable from the contact bores 234 with special tooling.

FIG. 7 is a rear perspective view of the end cap assembly 216 illustrating one of the wires 26 mated to corresponding contact 232 and the other wire 26 being assembled. The end cap assembly 216 includes a strain relief element 280. The wires 26 engage the strain relief element 280 to relieve stress and strain on the connection between the wire 26 in the corresponding contact 232. The strain relief element 280 may prevent rotation of the wire 26 and may also prevent unwanted removal of the wire 26. In the illustrated embodiment, the strain relief element 280 is represented by a bar, where the wires 26 are wrapped around the bar to generally hold the wires 26 in place. Other types of strain relief elements may be used in alternative embodiments to hold the general position of the wire 26 with respect to the end cap body 236.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon, reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 135 U.S.C. §12, sixth paragraph, unless and until such claim limitations expressly use the phrase “means for” followed by a statement of function void of further structure.

What is claimed is:

1. An end cap assembly for a light tube having a circuit board with lighting devices mounted thereto, the end cap assembly comprising:
an end cap body coupled to the light tube, the end cap body having an external mating face configured to mate with a socket connector of a fixture, the end cap body having contact bores therethrough extending along bore axes, the contact bores having inner ends and outer ends;
contacts removably received in the contact bores along the bore axes, the contacts having socket mating ends extending from the contact bores beyond the outer ends for mating with the socket connector, the contacts having wire termination ends opposite to the socket mating ends; and
wires terminated to the wire termination ends of the contacts, the wires being configured to be electrically connected to the circuit board.

2. The end cap assembly of claim 1, wherein the contacts are received in the contact bores in a snap fit to secure the contacts within the contact bores.

3. The end cap assembly of claim 1, wherein the contact bores include internal counter bores extending radially outward therefrom, the contacts having retention lances received in the counter bores to hold the contacts within the contact bores.

4. The end cap assembly of claim 1, wherein the contacts include deflectable retention lances, the contacts being loaded through the inner ends of the contact bores until the retention lances clear the outer end of the contact bores, the retention lances deflecting outward to engage the external mating face of the end cap body to secure the contacts with respect to the contact bores.

5. The end cap assembly of claim 1, wherein the wires are terminated to the contacts prior to the contacts being loaded into the contact bores.

6. The end cap assembly of claim 1, wherein the contacts are hollow along a length of the contact, the contacts receiving the wires through the wire termination ends such that the wire termination ends of the contacts circumferentially surround the corresponding wires.

7. The end cap assembly of claim 1, wherein the wire termination ends of the contacts are crimped to the wires to create mechanical and electrical connections between the contacts and the wires.

8. The end cap assembly of claim 1, wherein the contacts are stamped and formed into a generally tubular shape.

9. The end cap assembly of claim 1, wherein the contacts constitute poke-in wire contacts each having a mating finger, the wires being loaded through the wire termination ends, the mating fingers engaging the wires to create mechanical and electrical connections between the contacts and the wires.

10. The end cap assembly of claim 1, wherein the end cap body is circular in shape, the end cap body including a pair of the contact bores spaced apart from each other along a diameter of the end cap body.

11. The end cap assembly of claim 1, wherein the end cap body is disk shaped, the contact bores being equally spaced from a center of the end cap body.

12. The end cap assembly of claim 1, wherein each contact includes at least one projection extending outward therefrom, the at least one projection engaging the corresponding contact bore to hold the contact relative to the contact bore.

13. An end cap assembly for a light tube having a circuit board with lighting devices mounted thereto, the end cap assembly comprising;
an end, cap body coupled to the light tube, the end cap body having an external mating face configured to mate with a socket connector of a fixture, the end cap body having contact bores therethrough extending along parallel bore axes between inner ends and outer ends: and
contacts loaded into the contact bores along the bore axes, the contacts having socket mating ends extending from the contact bores beyond the outer ends for mating with the socket connector, the contacts having deflectable retention lances extending outward therefrom, the retention lances engaging the contact bores to hold the contacts in the contact bores, the contacts being electrically connected to the circuit board.

14. The end cap assembly of claim 13, wherein the contacts include deflectable retention lances, the contacts, being loaded through the inner ends of the contact bores until the retention lances deflect outward to secure the contacts within the contact bores.

15. The end cap assembly of claim 13, wherein the contacts are received in the contact bores in a snap fit to secure the contacts within the contact bores.

16. The end cap assembly of claim 13, wherein the wires are terminated to the contacts prior to the contacts being loaded info the contact bores.

17. An end cap assembly for a light tube having a circuit board with lighting devices mounted thereto and a lens covering the circuit board, the end cap assembly comprising;
an end cap body having a lens engagement, surface configured to engage the lens, the end cap body having an external mating face configured to mate with a socket connector of a fixture, the end cap body having contact bores therethrough extending along parallel bore axes; and
poke-in wire contacts received in the contact bores along the bore axes, the contacts having wire termination ends receiving wires therethrough and being electrically connected to the wires, the contacts having socket mating ends extending outward from the external mating lace for mating with, the socket connector, the contacts being electrically connected to the circuit board by the wires.

18. The end cap assembly of claim 17, wherein the end cap body includes a strain relief element, the wires engage the strain relief element.

19. The end cap assembly of claim 17, wherein the contacts each include a mating finger, the mating fingers engaging the wires to create mechanical and electrical connections between the contacts and the wires.

20. The end cap assembly of claim 17, wherein the contacts are hollow along a length of the contact, the contacts each having a mating finger, the contacts receiving the wires through the wire termination ends such that the wire termination ends of the contacts circumferentially surround the corresponding wires, the mating fingers engaging the wires when the wires are loaded into the wire termination ends.
